(19) United States
(12) Patent Application Publication
(10) Pub. No.: US 2020/0038155 A1
(43) Pub. Date: Feb. 6, 2020

(54) ORAL CLEANING DEVICE WITH IMPROVED NOZZLE DESIGN

(71) Applicant: KONINKLIJKE PHILIPS N.V., EINDHOVEN (NL)

(72) Inventors: BRIAN JOHANSKI, SNOHOMISH, WA (US); ANANDH BALAKRISHNAN, GOLD BAR, WA (US)

(21) Appl. No.: 15/735,638

(22) PCT Filed: May 24, 2016
(86) PCT No.: PCT/IB2016/053024

§ 371 Date: Dec. 12, 2017

(51) Int. Cl. A61C 17/02; A61C 17/028

(52) U.S. Cl. CPC A61C 17/0202; A61C 17/028

(57) ABSTRACT

An elongated nozzle (30) for an oral cleaning device (10), the elongated nozzle including: a proximal end (33) with an inlet orifice (36); a distal end (32) with an outlet orifice (42), where the outlet orifice is in fluid communication with the inlet orifice; and at least one structure (50a, 50b) located between the inlet orifice and the outlet orifice, the at least one structure configured to break a liquid droplet traveling through the nozzle into two or more smaller liquid droplets. The at least one structure can also be configured to recapture residual liquid (46) remaining in the nozzle and organize the recaptured residual liquid into at least one liquid droplet (46a, 46b). The structure may be a hydrophobic region that recaptures and organizes the residual liquid.

### FIELD OF THE INVENTION

The present disclosure is directed generally to oral care appliances for cleaning teeth using coordinated bursts of air and fluid, and particularly to a nozzle design that recaptures and utilizes residual liquid.

### BACKGROUND

Periodontal diseases are thought to be infectious diseases caused by bacteria present in dental plaques and biofilms. Removal of dental plaques and biofilms is highly important for the health of oral cavities. Tooth brushing is a highly effective method to remove dental plaque and biofilms from the teeth, provided the oral cleaning device is actually used in such a fashion to reach all areas where plaque resides.

Oral cleaning devices that clean the teeth with streams or bursts of liquid or a mixture of liquid droplets and air are effective at disrupting dental plaques and biofilm in the oral cavity, particularly in the interproximal areas of the teeth. These devices generally create liquid droplets when the liquid is brought into contact with a high velocity stream of air using a pump or similar arrangement.

Coordinated bursts of liquid and air use far less liquid per cleaning compared to a continuous stream of liquid. As a result, less liquid is used per cleaning and the user does not accumulate an uncomfortable volume of liquid in the mouth. This is particularly beneficial if the liquid is a mouthwash or similar liquid which shouldn't be swallowed by the user. Additionally, the alternating bursts of air and liquid provide superior dental plaques and biofilm removal and interdental cleaning.

Existing oral cleaning devices using coordinated bursts of liquid and air typically have a nozzle or other elongated structure that connects the handle of the device and an opening at the distal end of the nozzle through which the bursts of liquid and air are delivered to the teeth and gums. Between bursts, and/or when the cleaning device is turned off, residual liquid collects in the nozzle or elongated structure. Rather than forming a droplet of liquid that can be utilized during a subsequent burst, this residual water must be cleared from the nozzle or elongated structure.

Accordingly, there is a need in the art for oral cleaning devices that recapture the residual liquid from the nozzle and configure the recaptured liquid into one or more droplets of liquid.

### SUMMARY OF THE INVENTION

The present disclosure is directed to inventive oral cleaning devices with nozzles that break a burst of liquid into multiple optimal sized bursts of liquid, or recapture residual liquid and configure the recaptured liquid into multiple droplets of liquid for subsequent use. Various embodiments and implementations herein are directed to oral cleaning devices in which the nozzle is structured to automatically recapture the liquid that remains in the nozzle after a previous burst. The nozzle contains a structure such as patterned hydrophobic and/or hydrophilic regions, or patterned regions of alternating texture, that configure the residual liquid into multiple droplets that will form part of the coordinated bursts of liquid and air in the use of the device. Using the various embodiments and implementations herein, the oral cleaning device can conserve liquid and deliver multiple optimally sized droplets or shots during use.

Generally in one aspect, an elongated nozzle for an oral cleaning device includes: (i) a proximal end with an inlet orifice; (ii) a distal end with an outlet orifice, where the outlet orifice is in fluid communication with the inlet orifice; and (iii) at least one structure located between the inlet orifice and the outlet orifice, the at least one structure configured to break a liquid droplet traveling through the nozzle into two or more smaller liquid droplets.

According to an embodiment, the at least one structure comprises a hydrophobic region. According to an embodiment, the hydrophobic region comprises a hydrophobic coating and/or a hydrophobic microstructure.

According to an embodiment, the at least one structure comprises alternating hydrophobic and non-hydrophobic regions.

According to an embodiment, the at least one structure is further configured to recapture residual liquid remaining in the nozzle and organize the recaptured residual liquid into at least one liquid droplet.

According to an aspect is an oral cleaning device which includes: (i) a nozzle portion configured to direct a plurality of liquid droplets from an inlet orifice at a proximal end to an outlet orifice at a distal end thereof; (ii) an actuator; (iii) a liquid reservoir wherein in operation liquid is moved from the liquid reservoir into the inlet orifice; (iv) a system configured to drive a plunger or piston element toward the proximal end of the nozzle with sufficient force that air acted on by the plunger or piston element is forced into the nozzle at a high rate of speed sufficient to create a burst of liquid droplets when the moving air comes into contact with the liquid; and (v) a control unit configured to control the system to drive the plunger a predetermined number of times in response to a single actuation of the actuator; where the nozzle is configured to break a liquid droplet traveling through the nozzle into two or more smaller liquid droplets.

According to an embodiment, the oral cleaning device includes at least one structure located between the inlet orifice and the outlet orifice.

According to an embodiment, the nozzle is configured to recapture residual liquid remaining in the nozzle and organize the recaptured residual liquid into at least one liquid droplet.

Generally in one aspect, an elongated nozzle for an oral cleaning device includes: (i) a proximal end with an inlet orifice; (ii) a distal end with an outlet orifice, where the outlet orifice is in fluid communication with the inlet orifice; and (iii) at least one structure located between the inlet orifice and the outlet orifice, the at least one structure configured to break down a burst of liquid into multiple optimal sized bursts, and/or recapture residual liquid remaining in the nozzle after one or more previous bursts and organize the recaptured residual liquid into at least one liquid droplet.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of an oral cleaning device in accordance with an embodiment.

FIG. 2 is a schematic representation of the nozzle portion of an oral cleaning device in accordance with an embodiment.

FIG. 3 is a schematic representation of residual liquid in the nozzle portion of an illustrative oral cleaning device.

FIG. 4 is a schematic representation of residual liquid in the nozzle portion of an illustrative oral cleaning device.

FIG. 5 is a schematic representation of the nozzle portion of an oral cleaning device in accordance with an embodiment.

FIG. 6 is a schematic representation of the nozzle portion of an oral cleaning device in accordance with an embodiment.

### DETAILED DESCRIPTION OF EMBODIMENTS

The present disclosure describes various embodiments of an oral cleaning device that delivers coordinated bursts of liquid and air. More generally, Applicants have recognized and appreciated that it would be beneficial to provide an oral cleaning device in which the nozzle is structured to recapture residual liquid and automatically configure the recaptured liquid into small droplets of liquid that will be utilized as bursts or pulses of liquid in the next cleaning session. A particular goal of utilization of certain embodiments of the present disclosure is to conserve liquid and deliver more bursts or pulses during use, therefore more efficiently cleaning the oral cavity, particularly the interdental spaces.

Using the various embodiments and implementations herein, for example, the improved nozzle design can split a single “shot” of fluid into two separate shots, thereby increasing impact and improving performance. Various embodiments and implementations may utilize hydrophobic structures or other means in the nozzle to create an air gap the residual liquid (for example, “water slug”) in the nozzle, splitting it into two droplets and thereby two shots of liquid in a burst. This provides for better impact forces and better plaque removal.

The improved nozzle design disclosed and described herein can be used with any oral care appliance for cleaning teeth using coordinated bursts of air and fluid. One example of an oral care appliance that the improved nozzle design can be used with is any Airfloss® device available from Koninklijke Philips Electronics N.V.

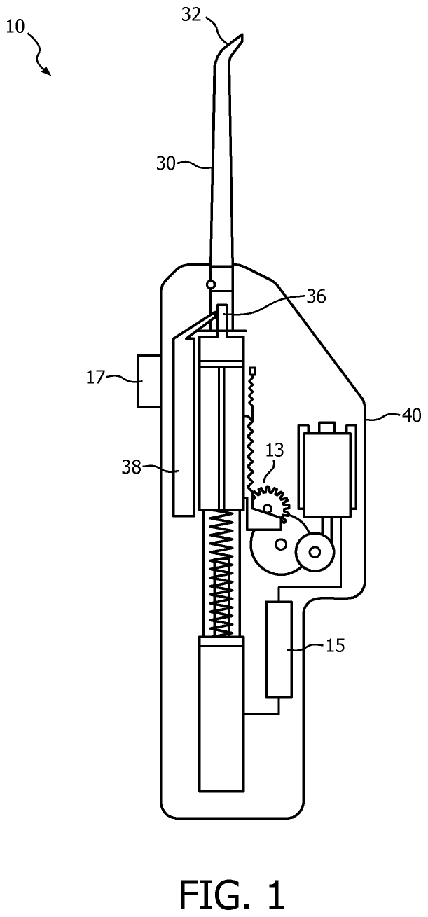

In view of the foregoing, various embodiments and implementations are directed to an oral cleaning device with an improved nozzle design that automatically recaptures residual liquid and configures the recaptured liquid into one or more shots of liquid for subsequent use. Referring to FIG. 1, in one embodiment, is a schematic cutaway representation of an oral cleaning device 10. Oral cleaning device 10 includes a nozzle 30 and a handle 40.

According to this embodiment, device 10 uses a mechanical spring-drive system 13 in the handle 40 to create the selected liquid droplet spray mode for dental cleaning. The mechanical spring-drive system 13 includes a motor and gear train arrangement with a drive gear, a plunger/piston that acts against a compression spring. A control unit 15 is included between a battery and the motor for control of the operation of the appliance. For example, control unit 15 can be activated or controlled by a power button or similar element 17 used to actuate the device. Movement of the spring-drive system 13 draws air into the device 10. Although device 10 is shown using a mechanical spring-drive system 13 to create the selected liquid droplet spray mode for dental cleaning in this embodiment, other systems to create coordinated bursts of liquid and air are possible.

According to an embodiment of device 10, elongated nozzle 30 extends outwardly from the device and can have a curved portion 32 at the distal end thereof, through which a spray of liquid droplets is directed for cleaning action against dental regions of the teeth. The curved portion 32 assists in convenient positioning of the nozzle 30 in the mouth by the user. At the proximal end 33 of the nozzle is an inlet orifice 36. Inlet orifice 36 can vary in size, typically between 0.5 mm and 10 mm.

Device 10 also includes an internal liquid reservoir 38 for a liquid such as water, mouthwash, cleaning liquid, or other liquid. Liquid in the reservoir is moved to the vicinity of the inlet orifice 36. When the spring-drive system 13 releases, air is expelled at high speed toward the inlet orifice 36. When the fast-moving air comes into contact with the liquid from the internal reservoir 38 which is adjacent inlet orifice 36, a spray of liquid droplets is produced which is expelled out through the nozzle 30.

The liquid droplets can be of various sizes, and the speed of the droplets can vary from relatively low speed, e.g. 10 meters per second, to a high speed of 200 meters per second or even greater. Typically, however, a 50 m/sec droplet velocity with droplets in a size range of 5 microns-0.5 mm will provide effective dental cleaning.

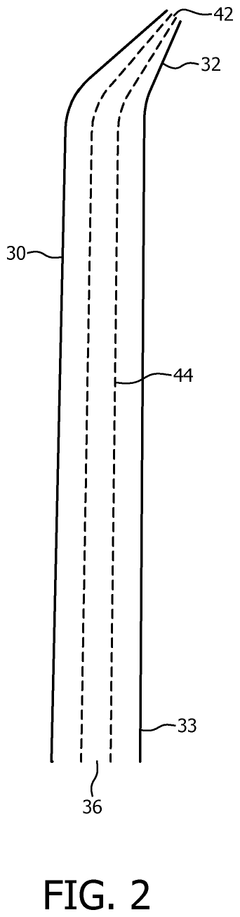

Referring to FIG. 2, in one embodiment, is the nozzle 30 of oral cleaning device 10. The nozzle can have a curved portion 32 at the distal end, through which a spray of liquid droplets is directed for cleaning action against dental regions of the teeth, and which assists in positioning of the nozzle 30 in the mouth by the user. The distal end also includes an outlet orifice 42 through which the coordinated liquid droplets and air are directed. Outlet orifice 42 can vary in size. Nozzle 30 can include a conduit 44 for the transmission of the coordinated liquid droplets and air from inlet orifice 36 at the proximal end 33 of the nozzle to outlet orifice 42 at the distal end of the nozzle. Conduit 44 can be the same diameter as nozzle 30, or can have a diameter smaller than nozzle 30, as shown in FIG. 2.

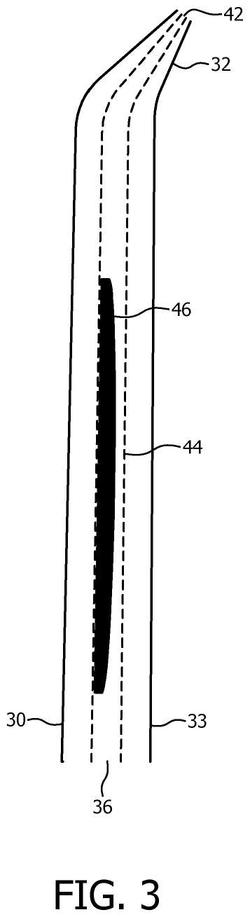

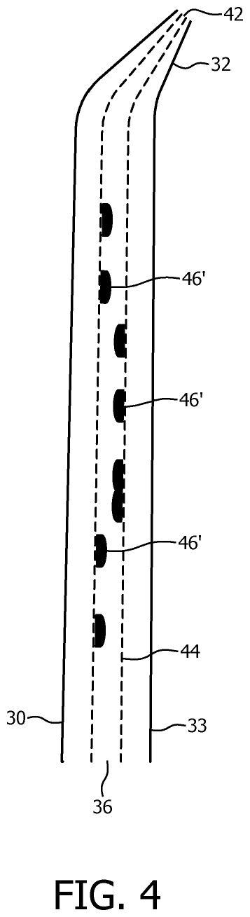

Following a cleaning session with oral cleaning device 10, there will be residual liquid 46 remaining inside nozzle 30 that was not expelled out of the outlet orifice 42. FIG. 3 shows a nozzle 30 with residual liquid 46 which remains inside the nozzle after a liquid air burst has been delivered. In an oral cleaning device 10, residual liquid 46 may be dispersed within the nozzle, can be a single large pool of liquid, can be several droplets of liquid (referred to as a “slug”), or a plurality of very small droplets of liquid. In the case of many small droplets of liquid 46′, as shown in FIG. 4, the droplets are typically too small to be useful when the oral cleaning device is used again and these droplets are expelled from outlet orifice 42.

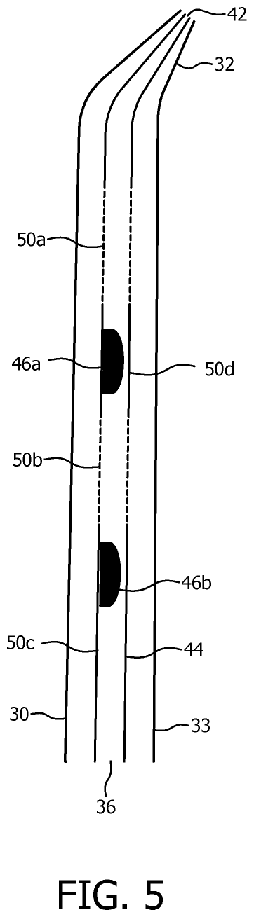

Referring to FIG. 5, in one embodiment, is a nozzle 30 structured or configured to recapture the residual liquid and form or configure it into one or more optimally sized droplets 46a, 46b. According to this embodiment, nozzle 30 includes one or more structures 50a and 50b which cause residual liquid 46 remaining inside the nozzle after a burst to automatically form into one or more optimally sized droplets 46a, 46b. Although shown as two alternating regions in FIG. 5, the structures 50 can be any number of regions from two to many regions, and can be alternating, or arranged in other patterns. According to an embodiment, the desired number and position of regions can be determined experimentally, and may depend on factors such as desired droplet size, the diameter of nozzle 30, the average volume of liquid remaining after a burst, and a wide variety of other factors.

In addition to the number regions, the size and/or shape of the automatically formed droplets 46a, 46b can be influenced or determined by the spacing and location of the regions. For example, regions that are spaced further apart may result in larger droplets, while regions that are spaced closer together may result in smaller droplets. According to an embodiment, the spacing of the regions can be determined experimentally, and may depend on factors such as desired droplet size, the diameter of nozzle 30, the average volume of liquid remaining after a burst, and a wide variety of other factors.

Various embodiments and implementations of the present disclosure utilize hydrophobicity or hydrophilicity in the flow path of the nozzle. According to an embodiment, structures 50a and 50b are hydrophobic regions of nozzle 30. For example, structures 50a and 50b may include or comprise a lining or coating that is substantially hydrophobic. As shown in FIG. 5, the hydrophobicity of structures 50a and 50b automatically repels residual liquid 46 and causes it to cluster in the non-hydrophobic regions 50c and 50d of nozzle 30, thereby forming discreet droplets 46a, 46b. The formed droplets can then be delivered in the next activation of the oral cleaning device 10, at which time they will be expelled from outlet orifice 42 and used in a pattern of coordinated bursts of liquid and air. According to one embodiment, therefore, the hydrophobicity of structures 50a and 50b can be of a nature that it does not interfere with delivery of bursts during use of the device. In other words, structures 50a and 50b can be structured or configured such that they do not disturb the size, shape, or configuration of liquid droplets during use of oral cleaning device 10. According to an embodiment, the hydrophobicity can be introduced by any material, coating, lining, or other structure sufficient to repel the liquid. For example, structures 50a and 50b may include or comprise a wax-like substance or material, a Teflon® coating, or any of a wide variety of materials.

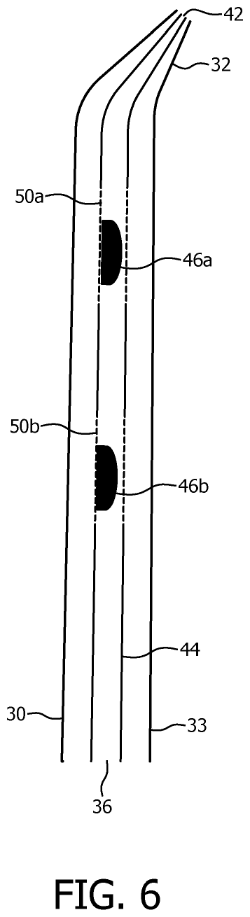

Alternatively, as shown in FIG. 6, structures 50a and 50b may include or comprise a lining or coating that is substantially hydrophilic. The hydrophilic nature of structures 50a and 50b automatically attracts residual liquid 46 and causes it to cluster in the hydrophilic regions of nozzle 30, thereby forming discreet droplets 46a, 46b. The formed droplets can then be delivered in the next activation of the oral cleaning device 10, at which time they will be expelled from outlet orifice 42 and used in a pattern of coordinated bursts of liquid and air. According to one embodiment, therefore, the hydrophilic forces of structures 50a and 50b can be of a nature that it does not interfere with delivery of bursts during normal use of the device. In other words, structures 50a and 50b can be structured or configured such that they do not disturb the size, shape, or configuration of liquid droplets during use of oral cleaning device 10. According to an embodiment, the material, coating, lining, or other structure can be any material that attracts the liquid.

According to an embodiment, structures 50a and 50b are super-smooth or super-rough regions of nozzle 30. Referring to FIG. 5, for example, structures 50a and 50b comprise a super-rough microscopic or nanoscopic architecture on their surfaces that minimizes liquid's adhesion to that surface. Referred to as the “lotus effect,” these rough surfaces result in hydrophobicity or superhydrophobicity as a result of the very high contact angles between the surface and the liquid. Due to the hydrophobicity of the super-rough regions, the residual liquid 46 in nozzle 30 will not collect on structures 50a and 50b, instead collecting in discreet droplets of a desired size in the alternating, neighboring regions 50c, 50d. The super-rough regions can be created using microscopic or nanoscopic architectures, or a combination of these architectures and coatings such as fluorochemical or silicone treatments, among many other possible coatings.

According to an embodiment, the one or more structures 50a and 50b are configured or structured to interact differently with different liquids. For example, the structure may only exert a hydrophobic or other automatic organizing force on a liquid comprising mostly water, and may exert little or no force on another liquid such as a mouthwash. Accordingly, the liquid and/or the one or more structures 50a and 50b can be specifically designed to control the properties of the liquid in nozzle 30.

According to an embodiment, the one or more structures 50a and 50b in the nozzle are patterned or random hydrophobic and/or hydrophilic regions, or patterned or random textured regions, that break down a burst of liquid into multiple optimal sized bursts, and/or configure residual liquid into multiple droplets. For example, structures 50a and 50b can be a pattern of hydrophobic regions, hydrophilic regions, or alternating hydrophobic and hydrophilic regions, where each region is separated from a neighboring region by the same spacing. As another example, structures 50a and 50b form a pattern where each region is separated from a neighboring region by variable distances. As yet another example, structures 50a and 50b form a pattern where the regions are randomly spaced. In addition to a pattern of hydrophobic regions, hydrophilic regions, or alternating hydrophobic and hydrophilic regions, structures 50a and 50b can be any random or non-random pattern of textures, including but not limited to smooth and/or rough regions. As yet another example, the structures can be a combination of textured regions, hydrophobic regions, and/or hydrophilic regions.

According to an embodiment, the one or more structures 50a and 50b in nozzle 30 exert a force on the liquid that is passing through the nozzle during use of oral cleaning device 10. This effect may be in conjunction with, or entirely separate from, recapture of residual liquid 46. For example, the one or more structures 50a and 50b in nozzle 30 could assist in the formation of liquid droplets of a desired size and/or shape during use of the device. As the coordinated bursts of liquid travel through nozzle 30 from inlet orifice 36 to outlet orifice 42, the one or more structures 50a and 50b can cause the liquid pulses or bursts to become smaller or larger. In the case of hydrophobicity of structures 50a and 50b, for example, the liquid droplets may decrease in size and/or change shape as they pass through the hydrophobic regions. These smaller droplets may be more efficient at cleaning the mouth.

According to yet another embodiment, the oral cleaning device 10 does not include a system that disperses the liquid into coordinated bursts of liquid and air. Instead, the device uses a constant stream of liquid that is pushed from the interior of device 10 through nozzle 30 and out outlet orifice 42. According to this embodiment, the nozzle 30 includes one or more structures 50a and 50b that cause dispersion of the liquid that is passing through the nozzle during use of oral cleaning device 10 into smaller droplets rather than a constant stream of liquid. For example, the hydrophobicity of one or more structures 50a and 50b can break the constant stream of liquid into smaller droplets of a desired size as the liquid passes through nozzle 30. Accordingly, the liquid is configured into droplets, which are more efficient at cleaning the mouth, in the nozzle without other structures in the handle or elsewhere in the device. According to this embodiment, the formation of droplets is accomplished entirely through one or more structures 50a and 50b.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A nozzle for an oral cleaning device, the nozzle comprising:
a proximal end with an inlet orifice;
a distal end with an outlet orifice, wherein the outlet orifice is in fluid communication with the inlet orifice by means of a conduit; and
at least one structure located on an interior portion of the conduit between the inlet orifice and the outlet orifice, the at least one structure configured to break a liquid droplet traveling through the nozzle into two or more smaller liquid droplets.

2. The elongated nozzle of claim 1, wherein the at least one structure comprises a hydrophobic region.

3. The elongated nozzle of claim 2, wherein the hydrophobic region comprises a hydrophobic coating.

4. The elongated nozzle of claim 2, wherein the hydrophobic region comprises a hydrophobic microstructure.

5. The elongated nozzle of claim 1, wherein the at least one structure comprises a plurality of alternating hydrophobic and non-hydrophobic regions.

6. The elongated nozzle of claim 1, wherein the at least one structure is further configured to recapture residual liquid remaining in the nozzle and organize the recaptured residual liquid into at least one liquid droplet.

7. An oral cleaning device comprising:
a nozzle portion configured to direct a plurality of liquid droplets from an inlet orifice at a proximal end through a conduit to an outlet orifice at a distal end thereof;
a liquid reservoir wherein in operation liquid is moved from the liquid reservoir into the inlet orifice;
a mechanical spring-drive gear system configured to drive a plunger portion toward the proximal end of the nozzle with sufficient force that air acted on by the plunger is forced into the nozzle at a high rate of speed sufficient to create a burst of liquid droplets when the moving air comes into contact with the liquid; and
an actuator for activating a control unit configured to control the mechanical spring-drive gear system to drive the plunger;
wherein the nozzle comprises at least one structure located on an interior portion of the conduit between the inlet orifice and the outlet orifice, the at least one structure configured to break a liquid droplet traveling through the nozzle into two or more smaller liquid droplets.

8. (canceled)

9. The oral cleaning device of claim 7, wherein the at least one structure comprises a hydrophobic coating.

10. The oral cleaning device of claim 7, wherein the at least one structure comprises a hydrophobic microstructure.

11. The oral cleaning device of claim 7, wherein the at least one structure comprises a plurality of alternating hydrophobic and non-hydrophobic regions.

12. The oral cleaning device of claim 7, wherein the nozzle is further configured to recapture residual liquid remaining in the nozzle and organize the recaptured residual liquid into at least one liquid droplet.

13. An elongated nozzle for an oral cleaning device, the elongated nozzle comprising:
a proximal end with an inlet orifice;
a distal end with an outlet orifice, wherein the outlet orifice is in fluid communication with the inlet orifice by means of a conduit; and
at least one structure located on an interior of the conduit, the at least one structure configured to recapture residual liquid remaining in the nozzle, and further configured to organize the recaptured residual liquid into at least one liquid droplet.

14. The oral cleaning device of claim 13, wherein the at least one structure is further configured to break a liquid droplet traveling through the nozzle into two or more smaller liquid droplets.

15. The oral cleaning device of claim 13, wherein the nozzle comprises a plurality of hydrophobic regions.
